(19) United States
(12) Patent Application Publication
(10) Pub. No.: US 2009/0007157 A1
(43) Pub. Date: Jan. 1, 2009

(54) Mapping Data Sources to a Procedural API

(75) Inventors: Robert D. Ward, Redmond, WA (US); Alexander T. Weinert, Seattle, WA (US); Craig V. McMurtry, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/770,532

(22) Filed: Jun. 28, 2007

(51) Int. Cl. G06F 9/44

(52) U.S. Cl. 719/328

(57) ABSTRACT

Described are embodiments directed to use of workflows for developing management agents that connect operations of a data source to a procedural API of an application. The management agents include a workflow that corresponds to an operation of a data source. The workflow includes a number of activities that make calls to the procedural API in order to perform the operation of the data source with respect to an object of the application. The use of workflows makes the development of management agents easier and more efficient.

### BACKGROUND

Implementing a centralized system for managing information provides a number of benefits, such as resource efficiency and data consistency. However, prior to the implementation of a centralized system, information must be imported from a number of disparate systems, each associated with a different remote application. Each of the remote applications will have a different remote procedural application programming interface (API) that is used to access (store or retrieve) information stored in the associated system. In order for a centralized system to import information from a remote system, a customized software connector must be developed in order to connect or map operations of the centralized system to the remote procedural API (of the associated application). The process of developing a software connector is labor intensive, because it requires the creation of customized code that is application specific.

It is with respect to these and other considerations that embodiments of the present invention have been made. Also, although relatively specific problems have been discussed, it should be understood that embodiments of the present invention should not be limited to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Described are embodiments directed to use of workflows for developing management agents that connect operations of a data source to a remote procedural API. The management agents include a workflow that corresponds to an operation of a data source. The workflow includes a number of activities that make calls to the remote procedural API in order to perform the operation of the data management system on an object. Using workflows makes the development of management agents easier and more efficient.

Embodiments may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures.

FIG. 1. illustrates a system that includes a centralized data management system according to an embodiment.

FIG. 2. illustrates a software environment with a management agent that includes a number of workflows, according to an embodiment.

FIG. 3 illustrates a block diagram of a software environment for creating management agents that include workflows.

FIG. 4 illustrates a graphical representation of a workflow according to an embodiment.

FIG. 5 illustrates an operational flow for generating a management agent that maps an operation of a data source to a procedural API.

FIG. 6 illustrates an operational flow for connecting a data source to a procedural API.

FIG. 7 illustrates a block diagram of a computing system suitable for implementing embodiments.

### DETAILED DESCRIPTION

Various embodiments are described more fully below with reference to the accompanying drawings, which form a part hereof, and which show specific illustrative embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Embodiments are described below for creating software applications, referred to below as management agents, which allow a data source to connect to an application with a remote procedural application programming interface (API). Although the embodiments below are described with respect to a data management system as the data source, in other embodiments the data source may be any system that stores and provides access to information. As will be appreciated by those with skill in the art, the term data source is used for purposes of simplicity, but is intended to encompass applications and systems that behave as both a data source and a data sink.

The embodiments described below provide for creating management agents using workflows. Workflows are models that are used to describe a process. Workflows include a set of activities (pieces of short or long running work) and describe the order of execution and relationships of the activities. Management agents that include workflows can be created more easily and efficiently than management agents created using conventional techniques.

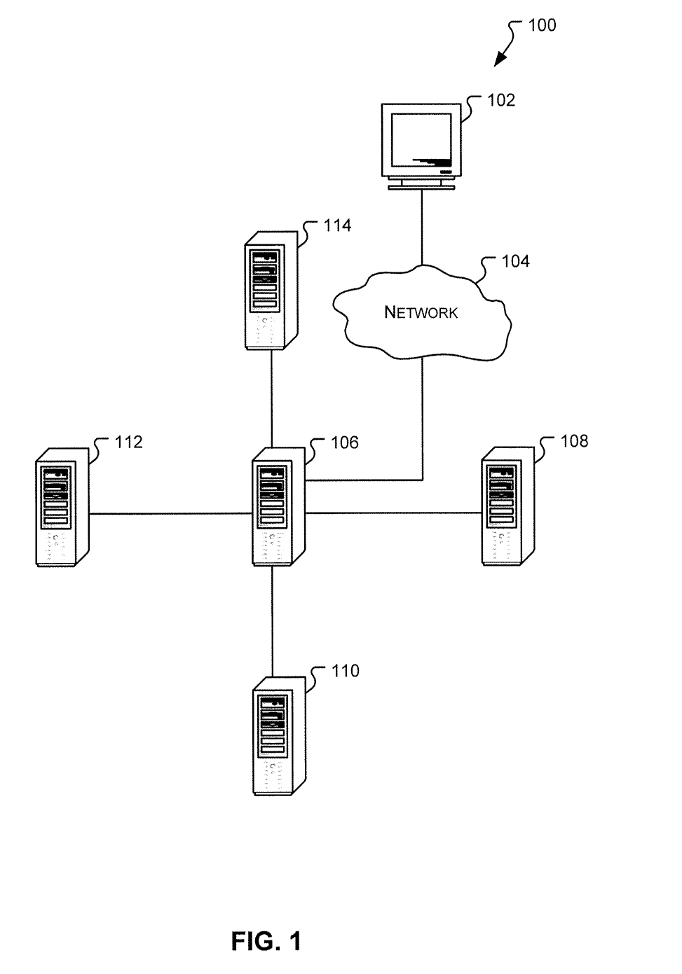

FIG. 1 illustrates a system 100 according to an embodiment. System 100 includes a client computer system 102 that accesses, through network 104, a server computer 106. System 100 also includes servers 108, 110, 112, and 114. Server 106 includes a centralized data management application that manages identity information (e.g., passwords, ID numbers, user names, authorization information, authentication information) within system 100. Although server 106 is described herein as storing identification information, it is not so limited, and in other embodiments server 106 manages other types of information.

Servers 108, 110, 112, and 114 include a variety of applications that store and use identity information. For example, in some embodiments servers 108, 110, 112, and 114 include e-mail applications, smart card applications, human resource applications, and/or directory service applications. Because server 106 manages the identity information for system 100, a user can efficiently change identity information in all of the applications on servers 108, 110, 112, and 114 by simply accessing the data management application on server 106. This avoids the additional steps required to change information on each individual application. For example, if a user's password is being changed, an administrator can simply change the information in the data management system on server 106, and the information is exported to the appropriate application(s) on the other servers, such as e-mail applications, smart card applications, human resource applications, and/or directory service applications.

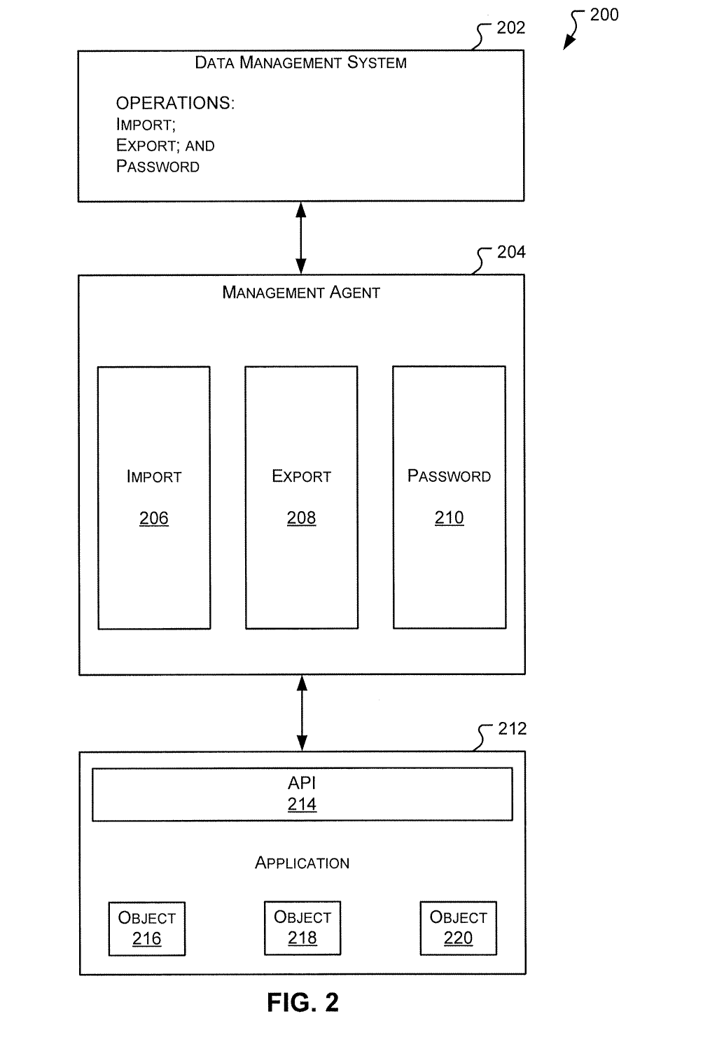

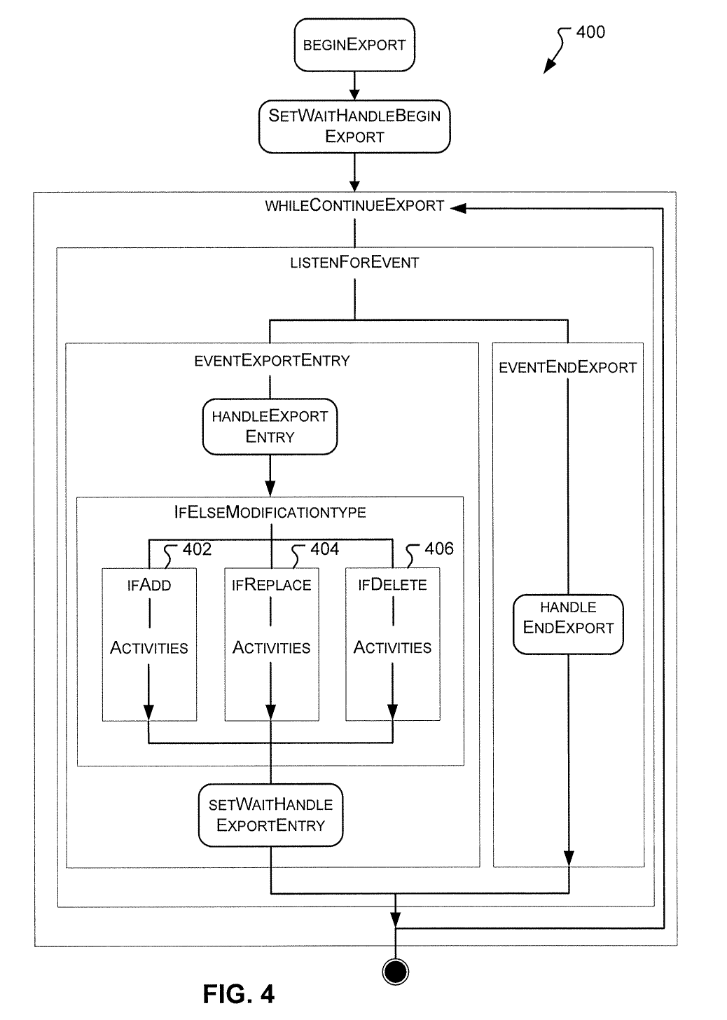

Server 106 also includes a number of management agents. The management agents allow the data management system on server 106 to import and export information to and from the applications on servers 108, 110, 112, and 114. The management agents are connectors that map the operations of the data management system on server 106 to the remote procedural API's of the applications on servers 108, 110, 112, and 114. As described in more detail below with respect to FIGS. 2 and 4, the management agents include workflows that are used to map the operations of the data management system to remote procedural API's. The workflows provide an easy and efficient way to create the management agents.

FIG. 2 illustrates a software environment 200 according to an embodiment. Environment 200 includes a data management system 202 which performs a variety of operations including importing information, exporting information, and password operations. Environment 200 also includes management agent 204 with workflows 206, 208, and 210. Furthermore, environment 200 has an application 212, which includes API 214 and a number of objects 216, 218, and 220.

The data management system 202 in embodiments is used to manage identity information, such as names, addresses, phone numbers, passwords, personal identifiers, authorization information, and authentication information. In one specific embodiment, data management system 202 is MICROSOFT® Identity Integration Server 2003. Data management system 202 provides a centralized system for managing identity information across a number of different applications and systems. System 202 performs a number of operations including importing information from a number of applications into data management system 202. Additionally, data management system 202 can also export information to other applications that utilize identity information. Finally, system 202 also performs password related operations, such as setting and changing of passwords.

In embodiments, data management system 202 includes a graphical user interface that allows a user to select an operation for performing by data management system 202. The graphical user interface can be menu driven to facilitate the selection of an operation for performing by data management system 202. In other embodiments, the graphical user interface may include graphical icons that may be selected as indications for performing the operations.

Application 212 is an application that stores and utilizes identity information. For example, in one embodiment application 212 is part of a human resource system that stores identity information about employees of an organization. In this embodiment, application 212 includes an employee object 216, user object 218, and administrator object 220. User object 216 represents an employee of an organization and includes identity information such as name, address, phone number, and employee identifiers. User object 218 represents, in embodiments, authorized users that may change information related to employees of the organization. Object 220 represents administrators that have all the privileges associated with a user, but also are allowed to make configuration changes to the human resource system. Each of objects 218 and 220 also include identity information, such as name, address, phone number, employee identifiers, and password.

Application 212 also includes API 214. As will be appreciated by those of ordinary skill in the art, application 212 exposes API 214 in order to allow other applications to interact with application 212. API 214 provides a number of methods that allows other applications to access or modify information in objects 216, 218, and 220.

Management agent 204 is a connector that allows data management system 202 to interact with application 212. As described above, management agent 204 includes a number of workflows 206, 208, and 210. Each individual workflow 206, 208, and 210 is associated with an operation of data management system 202. Although only three workflows 206, 208, and 210 are shown, it should be understood that in other embodiments management agent 204 will include more than three workflows 206, 208, and 210.

Each individual workflow 206, 208, and 210 is associated with an operation of data management system 202. In addition to being associated with an operation of data management system 202, workflows 206, 208, and 210 also relate to a specific schema that defines one of objects 216, 218, or 220. That is, an individual workflow is defined for performing an operation of data management system 202 with respect to a schema that defines one of the objects of application 212. As one example, import workflow 206 is defined to import information from a schema that defines employee object 216 of application 212. Import workflow 206 thus imports information from employee object 216 into data management system 202. Accordingly, a different workflow is defined to import information from schemas that define user object 218 or administrator object 220.

Defining a schema facilitates the connection between the application 212 and the data management system 202. A schema defines the particular classes and attributes of an object in application 212. Once the schema is defined, the management agent 204, and consequently workflows 206, 208, and 210, understand what attributes in an object relate to specific information such as passwords, usenames, addresses, etc. Having defined the schema, management agent 204 can import and export particular types of information to and from the objects of application 212.

System 200 generally operates as explained below. When information is added or changed in application 212, the changes are imported into data management system 202 to ensure that system 202 includes up-to-date information. Accordingly, a user may import the changes into data management system 202. A user may indicate, using a graphical user interface, an object (e.g., employee object 216) of application 212 from which to import data into data management system 202. After receipt of the indication, data management system 202 will initiate management agent 204 to begin importing information from employee object 216. As described in greater detail below with respect to FIG. 4, workflows, including workflows 206, 208, and 210, include a set of activities that when executed perform functions that are a part of the process defined by a workflow.

Thus, import workflow 206 includes activities with the necessary functionality to import information from employee object 216 into data management system 202. Import workflow 206 includes activities that make the necessary calls to API 214 to retrieve information from employee object 216 in data management system 202. The activities within import workflow 206 will also create the necessary file for storing the information retrieved from employee object 216. In some embodiments, import workflow 206 will also include activities that change the format of data from a format used in employee object 216 into an appropriate format for use by data management system 202.

In order to perform the process of importing information from employee object 216, a number of input parameters are provided to import workflow 206. The input parameters may include in embodiments, a file or object name that contains the data to be imported, a directory name which identifies the directory in which the file or object is stored, an object type that describes the type of object from which information is being imported, a user name and password associated with the necessary privileges for accessing employee object 216, and an indication of whether the import is a full import of all the information in employee object 216 or a partial import. The input parameters will be passed to import workflow 206, which will be executed in a workflow runtime engine. After execution, workflow 206 will pass output parameters (namely data in a format ready for use by data management system 202) to data management system 202.

Similarly, export workflow 208, in embodiments, includes a number of activities for performing the process of exporting information from data management system 202 to application 212. The activities include making the necessary calls to API 214 to store information within an object and/or create an object, and modifying data from a format stored within data management system 202 into an appropriate format for application 212.

As one example, the export operation may be performed when a new employee has joined an organization, and identity information is input into data management system 202. In order for the employee's information to be included in the human resource system, the identity information will be exported from data management system 202 into application 212. A user selects the export operation using a graphical user interface of data management system 202. The user identifies the specific information to be exported into application 212. In response, data management system 202 will initiate management agent 204 for exporting the indicated information.

In order to perform the process of exporting data, input parameters are passed to export workflow 208. The input parameters include in embodiments, a file or object name that contains the data to be exported, a directory name which identifies the directory into which the information will be exported, an object type that describes the type of object to which information is being exported, a user name and password associated with the necessary privileges for accessing application 212. The input parameters are passed to export workflow 208. The export workflow 208 and the associated activities are executed by a workflow runtime engine. After completion, export workflow 208 will pass output parameters, namely exported data, to application 212.

Password workflow 210 operates similar to import workflow 206 and export workflow 208, however it is specific to importing and exporting password information to and from data management system 202. Password workflow 210 can be used to change or set passwords from either data management system 202 or application 212.

Password workflow 210 includes the necessary activities to perform password related processes. For example, password workflow 210 includes calls to API 214 that are necessary for importing or exporting password information to and from data management system 202. Password workflow 210 also includes activities that modify password information from a first format into a suitable format for use by data management system 202 and application 212.

To perform password related processes, password workflow 210 is passed input parameters that may include, file or object names associated with a password, a directory name where the information is imported from or exported to, and a user name associated with a password. Once the parameters are passed to password workflow 210, a workflow runtime engine executes workflow 210 and generates output parameters, i.e., password data. The output parameters are then passed to data management system 202 or application 212.

It should be understood that environment 200 is presented for illustrative purposes only. In embodiments, environment 200 includes more, or less, features than illustrated in FIG. 2. For example, although workflows 206, 208, and 210 are illustrated as individual workflows, in embodiments workflows 206, 208, and 210 may include more than a single workflow. As one example, export workflow 208 will include three workflows in some embodiments. To export information from data management system 202 to application 212, a connection to application 212 is first established by data management system 202. Also, after completing the export of information, the connection to application 212 is torn down. In this embodiment, export workflow 210 is actually three workflows. A first workflow is executed to establish a connection between data management system 202 and application 212, the second workflow is executed to export the selected information, and the third workflow is executed to tear down the connection established by the first workflow. In embodiments, the workflows for establishing and tearing down connections to application 212 could be reused by other workflows, such as import workflow 206 and password workflow 210.

Furthermore, as described above, workflows are defined for a single operation of the data management system 202 in relation to a schema that defines an object of application 212. As will be appreciated by those with skill in the art, applications can oftentimes have a large number of object types. In these embodiments, management agent 202 will include a large number of workflows for importing and exporting information to and from all of the object types. Accordingly, management agent 204 is not limited to the workflows illustrated in FIG. 2. In other embodiments, management agent 204 includes a number of different workflows, for connecting data management system 202 to application 212.

In addition to a number of workflows, management agent 202 will also include other components, in embodiments. For example, in one embodiment, management agent 202 also includes a runtime engine that is used in executing work flows 206, 208, and 210.

In embodiments, environment 200 is implemented in system 100. For example, data management system 202 and management agent 204 are implemented in server 106, while application 212 is implemented in any one of servers 108, 110, 112, and 114. In this embodiment, the server 106 will include a number of management agents 204 that allow interaction between data management system 202 and a number of applications, such as application 212. In alternative embodiments, the management agent 204 may be stored on one or more of servers 108, 110, 112, and 114 instead of server 106.

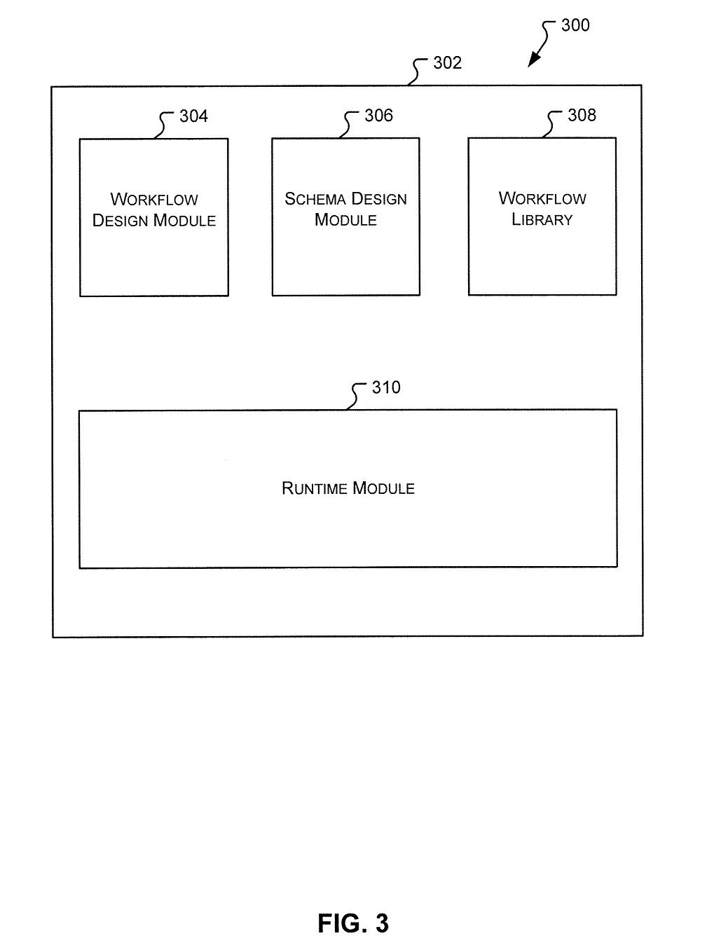

FIG. 3 illustrates a software environment 300 according to an embodiment. Environment 300 includes a management agent development application 302, which includes a workflow design module 304, a schema design module 306, a workflow library 308, and a runtime module 310. Management agent development application 302 is used to develop and implement management agents, such as management agent 204, described with respect to FIG. 2. As will be appreciated by those of skill in the art, application 302 can be incorporated as a part of a software development kit that includes additional software development applications.

Design module 304 is used to design workflows for use in management agents that connect operations of a data source to a remote procedural API. As described above, a workflow is a model of a process. In the case of mapping a data source to a remote procedural API, a workflow defines the process by which an operation of the data source can be performed on an object that is accessed using the remote procedural API. A workflow includes a set of activities that provide functionality for performing the process defined by the workflow. Workflow design module 304 has, in embodiments, a graphical user interface with tools that allow a user to easily design and create workflows by dragging and dropping activities into a defined workflow. A graphical representation of a workflow is described below with respect to FIG. 4. In some embodiments, workflow design module 304 has the flexibility to allow a user to define and create workflows (or portions of workflows) using graphic tools, and also provide the option of allowing workflows (or portions of workflows) to be defined and created completely in code.

In addition to workflow design module 304, agent development application 302 also includes a schema design module 306. As described above, a workflow defines an operation of a data source in relation to a schema that defines an object, which is accessed using the remote procedural API. The schema design module 306 allows a user to create a schema that defines objects within an application that will be accessed using the remote procedural API. The schema design module 306 allows a user to create schemas that define different classes of objects and their associated attributes. For example, the application that exposes a remote procedural API may be a human resource application with a number of objects such as employees, users, and administrators. In order to design a workflow to perform operations such as importing or exporting data to and from the objects, a schema must first be defined for each object in the application. That is, a schema is designed that defines the employee objects, another schema is designed that defines the user objects, and a third scheme is designed that defines the administrator objects. Schema design module 306 allows a user to define the necessary schemas.

To facilitate the development of workflows, agent development application 302 also includes workflow library 308, which includes a number of preloaded workflows and activities for including in workflows. In developing applications for connecting data sources with procedural APIs, there are a number of operations that will be common for the data sources. For example, importing and exporting data from a data source are common operations. Therefore, workflow library 308 will, in embodiments, include preloaded activities and workflow templates for generating management agents that include workflows for importing and exporting data from a data source to and from a defined schema. A workflow template for exporting information from a data source is described below with respect to FIG. 4.

Runtime module 310 is used to execute the workflows generated using workflow design module 304. In embodiments, runtime module 310 is incorporated into each management agent that is generated using application 302. Runtime module 310 executes the activities within a workflow to perform the operations defined by the workflow. As those with skill in the art will understand, runtime module 310 may have additional functionalities that depend upon the workflows that it executes.

FIG. 4 illustrates a graphical representation of a workflow 400 that is a model of a process for exporting information from a data source to an application with a remote procedural API. As can be seen in FIG. 4, workflow 400 includes graphical representations of states and event handling that occur during the process of exporting information. In embodiments, the graphical representation of a workflow is made using a standardized language for object modeling, such as the Unified Modeling Language.

Workflow 400 is an incomplete template that includes locations 402, 404, and 406 where activities can be inserted. In the specific embodiment shown in FIG. 4, the activities relate to modifications made to information during export of the information from the data source. The modifications include adding, deleting, or replacing data in the information that is being exported. The activities may include calls to a remote procedural API for modifying the exported information in order to make it suitable for exporting to an application.

In embodiments, workflow 400 may be created using a workflow design module such as module 304 described above with respect to FIG. 3. The design module can provide a number of preloaded activities that are graphically represented. A user can then simply drag and drop the graphics representing the activities into locations 402, 404, and 406 to complete the workflow 400. Indeed in some embodiments, workflow 400 is included as a preloaded template within a workflow library such as library 308 in FIG. 3. The workflow designer for creating workflow 400, in embodiments, allows a user to generate customized activities using code. In these embodiments, users can code customized activities and insert the customized activities into locations 402, 404, and 406.

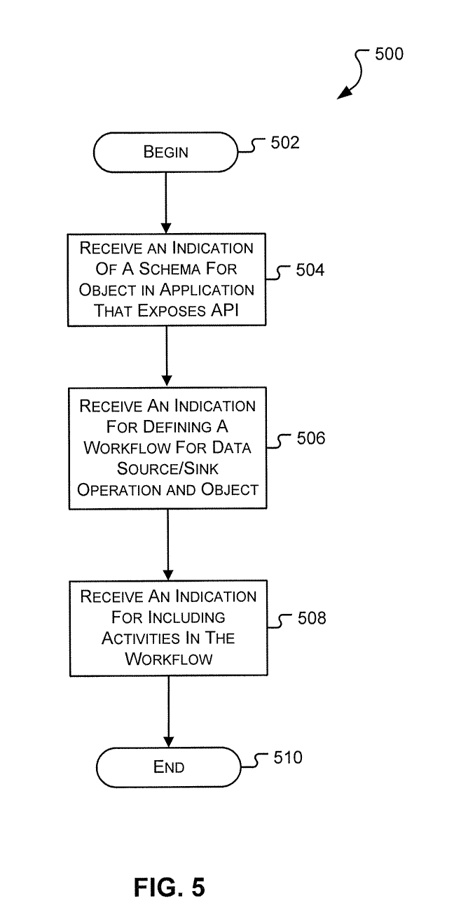

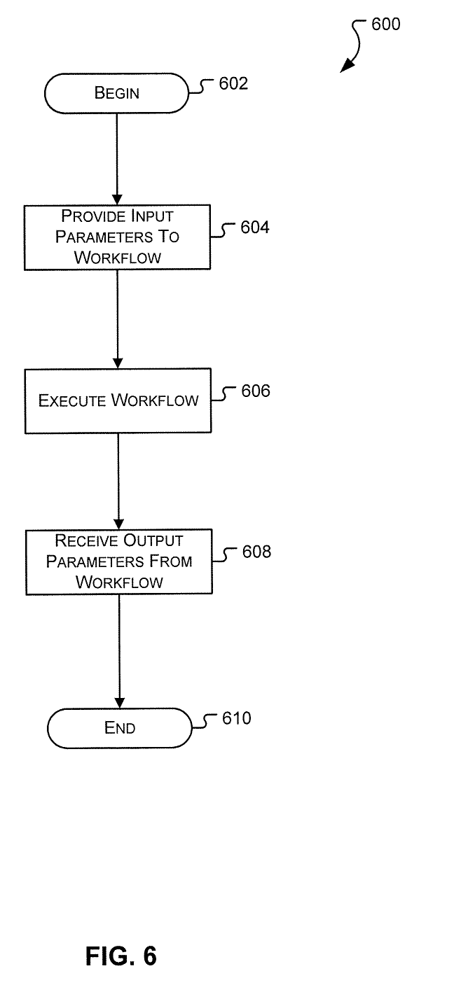

FIGS. 5 and 6 illustrate operational flows 500 and 600, according to embodiments. Operational flows 500 and 600 may be performed in any suitable computing environment. For example, the operational flows may be executed using environments such as illustrated in FIG. 2 and FIG. 3. Therefore, the description of operational flows 500 and 600 may refer to at least one of the components of FIG. 2 and FIG. 3. However, any such reference to components of FIG. 2 and FIG. 3 is for descriptive purposes only, and it is to be understood that the implementations of FIG. 2 and FIG. 3 are non-limiting environments for operational flows 500 and 600.

Furthermore, although operational flows 500 and 600 are illustrated and described sequentially in a particular order, in other embodiments, the operations may be performed in different orders, multiple times, and/or in parallel. Further, one or more operations may be omitted or combined in some embodiments.

FIG. 5 illustrates an operational flow 500 for creating a management agent that connects a data source with an application that exposes a procedural API. The management agent includes a workflow. Operational flow 500 begins at begin operation 502. As described above, the management agent is used to connect a data source with an application that exposes a procedural API for accessing objects in the application. In embodiments, the data source is a centralized data management system that is used to manage information such as identity information. The application that exposes a procedural API is an application that utilizes identity information, examples including human resource applications, smartcard applications, and e-mail applications. The application includes a number of objects such as for example user objects, employee objects, administrator objects, etc.

At receive indication of schema operation 504, a schema is established for an object of the application. The schema defines the classes and attributes of an object in the application. In some embodiments, receive indication of schema operation 504 is performed by a schema design module such as schema design module 306 described above with respect to FIG. 3. A user can indicate the schema design module to define a schema. The schema established during receive indication of schema operation 504, facilitates the connection between the data source and the procedural API. Once the schema is defined, the management agent, and consequently workflows of the management agent, understands which attributes of an object relate to specific information such as passwords, usernames, addresses, etc. With the schema defined, the management agent can import and export particular types of information to and from the objects of the application.

After receive indication of schema operation 504, flow passes to receive indication of workflow operation 506, where an indication for defining a workflow is received. In embodiments, operation 506 is performed by a workflow design module such as workflow design module 304 described above with respect to FIG. 3. The indication may be from a user interacting with a graphical user interface. For example, a user may click on a menu or icon to indicate that a workflow is to be defined. Alternatively, a user may use procedural commands that declare that a workflow is to be defined.

As explained above, a data source typically has a number of operations, including operations for importing information to and exporting information from the data source. A workflow provides a model that defines the process by which an operation is performed with respect to an object of the application. The workflows include a number of activities that perform the necessary functions for performing the operation of the data source with respect to an object of the application.

After operation 506, flow passes to receive an indication for including activities operation 508. Operation 508 is in embodiments also performed by a workflow design module, such as module 304. During operation 508, a user indicates the specific activities that are included within the workflow defined at operation 506. The activities define the functionality for performing the process defined by the workflow. In embodiments, the activities will include calls to the API of the application. For example, in order to export information into an object of the application, an activity will be included in the workflow that makes the necessary calls to the API to include the information in the object of the application.

The indication for including activities is provided by a user using the workflow design module. In one embodiment, the workflow design module includes a graphical user interface, and a user may provide indications of activities to include in the workflow by clicking on menus or other graphical icons. Alternatively, a user can provide the indication procedurally via code in the workflow design module. Operation flow 500 ends at operation 510.

FIG. 6 illustrates an operational flow 600 for connecting a data source to an application having a remote procedural API. Operational flow of 600 begins at begin operation 602. In embodiments, operational flow 600 is performed at least in part by a management agent that includes a workflow. In embodiments, the data source is a centralized data management system that is used to manage information such as identity information. The application that exposes a procedural API is an application that utilizes identity information, examples including human resource applications, smartcard applications, and e-mail applications. The application includes a number of objects such as user objects, employee objects, administrator objects, etc.

Flow passes from begin operation 602 to provide input parameters operation 604, where parameters are provided to a workflow. The workflow defines a process for performing an operation of the data source with respect to an object in the application. The workflow includes a number of activities each providing functionality for performing the process defined by the workflow. The parameters that are provided at operation 614, will depend upon the specific operation defined by the workflow. In one embodiment, the workflow defines the process for exporting information from the data source to an object in the application. In this embodiment, the parameters provided to the workflow at operation 604 may include for example, file or object names that contain the data to be exported and the location for exporting the information to, an object type that describes the type of object to which information is being exported, and a user name and password associated with the necessary privileges for accessing the object into which the data will be exported. As will be appreciated, the specific parameters provided at operation 604 will vary depending on the operation defined by the workflow.

After operation 604, flow passes to execute the workflow operation 606, where the workflow is executed. Operation 606 includes executing the activities that make up the workflow. Activities may include for example, calls to the API of the application. Also, the activities may include making modifications to data that is being imported or exported. In embodiments, execute workflow operation 606 is performed by a runtime engine, such as runtime engine 310 described above with respect to FIG. 3.

After execution of the workflow at operation 606, flow passes to receive output parameters operation 608. At operation 608, the workflow provides output parameters that can be passed to the application or the data source, depending on the specific operation. In one embodiment, the operation is an import operation for importing information from the application into the data source. In this embodiment, the output parameters are a file, or information, that can be passed to the data source for storage or use. The specific parameters that are receive at operation 608, will depend upon the specific operation that is performed using the workflow. Flow then passes to end operation 610, where operational flow 600 ends.

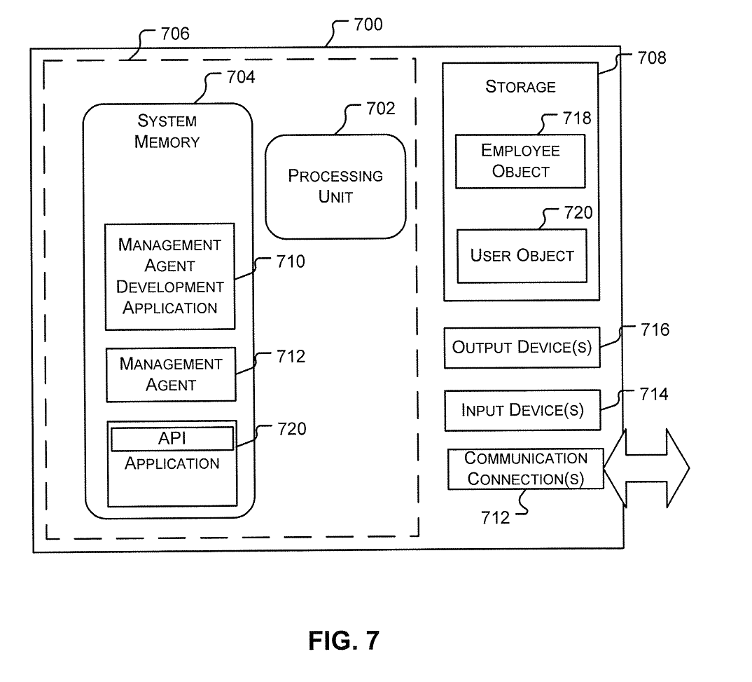

FIG. 7 illustrates a general computer system 700, which can be used to implement the embodiments described herein. The computer system 700 is only one example of a computing system and is not intended to suggest any limitation as to the scope of use or functionality of the computer and network architectures. Neither should the computer system 700 be interpreted as having any dependency or requirement relating to any one or combination of components illustrated in the example computer system 700. In embodiments, system 700 may be used as a receiving server and/or a central server described above with respect to FIGS. 2 and 3.

In its most basic configuration, system 700 typically includes at least one processing unit 702 and memory 704. Depending on the exact configuration and type of computing device, memory 704 may be volatile (such as RAM), non-volatile (such as ROM, flash memory, etc.) or some combination of the two. This most basic configuration is illustrated in FIG. 7 by dashed line 706. System memory 704 stores applications that are executing on system 700. An example of an application that may be stored in memory 704 is a management agent development application 710, such as application 302 described above with respect to FIG. 3. As another example, an application 720 that exposes an API that is mapped to a data source may also be stored in memory 704, as well as a management agent that connects application 720 with the data source.

Additionally, system 700 may also have additional features/functionality. For example, device 700 may also include additional storage 708 (removable and/or non-removable) including, but not limited to, magnetic or optical disks or tape. Such additional storage is illustrated in FIG. 7 by storage 708. Computer storage media includes volatile and nonvolatile, removable and non-removable media implemented in any method or technology for storage of information such as computer readable instructions, data structures, program modules or other data. Memory 704 and storage 708 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 700. Any such computer storage media may be part of system 700.

As those with skill in the art will appreciate, storage 708 may store a variety of information. Among other types of information, storage 708 may store objects associated with application 720. The objects may include for example employee object 718 and user object 720. These objects may be used in importing and exporting information to and from application 720 and a data source.

System 700 may also contain communications connection(s) 712 that allow the system to communicate with other devices. Communications connection(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

System 700 may also have input device(s) 714 such as keyboard, mouse, pen, voice input device, touch input device, etc. Output device(s) 716 such as a display, speakers, printer, etc. may also be included. All these devices are well know in the art and need not be discussed at length here.

Reference has been made throughout this specification to “one embodiment” or “an embodiment,” meaning that a particular described feature, structure, or characteristic is included in at least one embodiment. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications have been illustrated and described, it is to be understood that the invention is not limited to the precise configuration and resources described above. Various modifications, changes, and variations apparent to those skilled in the art may be made in the arrangement, operation, and details of the methods and systems disclosed herein without departing from the scope of the claimed invention.

We claim:

1. A method of creating a management agent for connecting a data source with an application that exposes a procedural API, wherein the management agent comprises a workflow, the method comprising:
receiving an indication that defines a workflow corresponding to an operation of the data source and an object of the application, wherein the workflow comprises a plurality of activities;
receiving an indication for including an activity in the workflow, wherein the activity makes calls to the procedural API to perform the operation of the data source with respect to the object; and
storing the workflow and activities in memory.

2. The method of claim 1, wherein the operation comprises importing information from the application into the data source.

3. The method of claim 1, wherein the operation comprises exporting information from the data source into the application.

4. The method of claim 1, wherein the workflow is a first work flow, and the method further comprises:
receiving an indication defining a second workflow for connecting the data source to the application, wherein the second workflow comprises a second plurality of activities; and
receiving an indication defining a third workflow for disconnecting the data source from the application, wherein the third workflow comprises a third plurality of activities.

5. The method of claim 1, wherein the data source is a data management system that manages identity information.

6. The method of claim 1, further comprising executing the workflow using a runtime engine.

7. The method of claim 1, wherein the receiving an indication that defines a workflow and the receiving an indication for including an activity in the workflow are performed using a workflow design module.

8. The method of claim 7, wherein the receiving an indication for including an activity in the workflow, comprises selection of a graphical element displayed in a graphical user interface of the design module.

9. The method of claim 8, wherein the receiving an indication that defines a workflow, comprises selection of a graphical element displayed in a graphical user interface of the design module.

10. A method of connecting a data source to an application having a procedural API, the method comprising:
providing input parameters to a workflow to perform an operation of the data source on an object of the application, wherein the workflow comprises a plurality of activities;
executing the workflow and the plurality of activities, wherein the plurality of activities make calls to the procedural API to perform the operation of the data source with respect to the object;
receiving output parameters from the workflow; and
storing the output parameters in memory.

11. The method of claim 10, wherein the operation comprises importing information from the application into the data source and the receiving is performed by the data source.

12. The method of claim 10, wherein the operation comprises exporting information from the data source into the application and the receiving is performed by the application.

13. The method of claim 10, wherein the data source is a data management system that manages identity information.

14. The method of claim 13, wherein the application is selected from the group consisting of a human resource application, an e-mail application, a smart card application, and a directory service application.

15. The method of claim 10, wherein the executing the workflow is performed by a runtime engine.

16. A computer readable medium storing computer executable components comprising:
a design module for defining a workflow that corresponds to an operation of a data management system performed with respect to an object of an application, wherein the workflow comprises an activity; and
a runtime module for executing the workflow and the activity, wherein the activity makes a call to a procedural API of the application to perform the operation of the data management system with respect to the object.

17. The computer readable medium of claim 16, further comprising a schema design module for establishing a schema that defines the object of the application.

18. The computer readable medium of claim 16, further comprising a workflow library comprising a plurality of preloaded activities.

19. The computer readable medium of claim 16, wherein the design module comprises a graphical user interface operable to display a graphical representation of the workflow.

20. The computer readable medium of claim 16, wherein the data source is a data management system that manages identity information.
